(19) United States
(12) Patent Application Publication
(10) Pub. No.: US 2017/0055675 A1
(43) Pub. Date: Mar. 2, 2017

(54) LIPSTICK MINE MADE OF AT LEAST TWO PASTY SUBSTANCES

(71) Applicant: Weckerle GmbH, Weilheim (DE)

(72) Inventors: Joachim Jäger, Obereglfing (DE); Sven Droste, Peissenberg (DE)

(21) Appl. No.: 15/207,820

(22) Filed: Jul. 12, 2016

(30) Foreign Application Priority Data
Sep. 1, 2015 (EP) 15183307.6

(51) Int. Cl. A45D 40/16; B29C 45/72; B29C 45/22; B29C 45/14

(52) U.S. Cl. CPC A45D 40/16; B29C 45/14336; B29C 45/72; B29C 45/22; B29K 2621/00

(57) ABSTRACT

A method, a dosing device and a system for manufacturing of a lipstick mine out of at least two pasty substances are described. The method comprises inserting of a first end portion of a dosing device into a form whereby the first end portion of the dosing device comprises at least one outlet nozzle, filling of the first end portion of the dosing device with a first pasty substance, increasing of the gas pressure in the first end portion of the dosing device whereby the first pasty substance through the pressure is pressed out of the at least one outlet nozzle, removing the first end portion of the dosing device out of the form and filling up the form with a second pasty substance.

### TECHNICAL FIELD

The invention generally concerns a method, a device and a system for filling a form with at least two pasty substances and in particular a method, a device and a system for filling a form to create a lipstick mine out of at least two pasty substances.

### BACKGROUND

In known methods for forming of pasty substances, for example for manufacturing of lipstick mines, the one pasty substance to be formed is filled by ease of a filling station in its hot and liquid condition into individual forms. The filled substance is then cooled by ease of a cooling station in the forms and after the cooling process removed by ease of a removing station in solid condition out of the forms.

If the lipstick mine however shall not only consist of a single pasty substance to be formed, but of several, then with the known methods there is only a layering of different pasty substances possible. For example, U.S. Pat. No. 4,602,886 describes such a layering of different pasty substances, wherein first of all a first pasty substance is filled into the form and then another pasty substance and so on until the form is filled up.

Most of the time more complex designs are desired where the pasty substances are not just layered, but result in patterns. This is desired not only because of esthetical reasons but as well for ensuring a better distribution of different pasty substances during the utilization of the lipstick. Otherwise with a layering of different pasty substances by use of the lipstick first of all the pasty substance would be used, which forms the top most layer and then consecutively the pasty substances would be used, which form the further layers.

In DE 10 2005 037 451 A1 a method and a device is described, with that several pasty substances can be filled into one form and thereby result in a spiral pattern. Thereby the different pasty substances are dosed from separate supply lines into the forms, wherein during the filling the supply lines are in contact with the wall of the form and are twisted in the forms and simultaneously are moved out of the forms, so that the different pasty substances spirally spread in the form.

However, with the methods and devices known in the art only lipstick mines with very simple designs for the different pasty substances can be formed. Basically, there is a need for devices and methods with which lipstick mines can be manufactured, in which the at least two pasty substances form more complicated designs respectively structures which result in a particular pattern. The task of the present invention therefore consists in the provision of an appropriate method, an appropriate device and an appropriate system.

### SUMMARY

This task is solved according to the invention through the subject matters of the independent claims. Further preferred embodiments can be found in the dependent claims.

A method according to the invention for filling of a form with at least two pasty substances, wherein the form in particular is adapted for forming of lipstick mines, comprises introducing of a first end portion of a dosing device into the form, wherein the first end portion comprises at least one outlet nozzle, filling of the first end portion of the dosing device with a first pasty substance, increasing the gas pressure in the first end portion of the dosing device, wherein the first pasty substance through the pressure is pressed out of the outlet nozzle of the dosing device, removing of the first end portion of the dosing device out of the form and subsequent filling up of the form with a second pasty substance.

The two inserted pasty substances can thereby differ for example in chemical composition, color, viscosity or other characteristics. Hereby, several characteristics can differ, it is also conceivable, that only one characteristic is different or none. For example, through the utilization of two pasty substances with two different colors a recognizable pattern in the lipstick mine can be created.

The insertion of the first end portion of the dosing device into the form can be of that kind that the form is moved relatively to the dosing device, the dosing device therefore stays on the spot and the form moves in the direction of the dosing device. But in contrast to that it is also possible that the dosing device moves relatively to the form, therefore the form stay on the spot and the dosing device moves in the direction of the form. Alternatively it is also conceivable that the form and the dosing device move to one another therefore both parts move relatively to one another. So that at least the first end portion of the dosing device can be inserted into the form and this preferably happening contactless, the first end portion of the dosing device is for example adapted to have a smaller outer diameter than the inner diameter of the form.

The filling of the first end portion of the dosing device can for example happen in that way that an already dosed, that is measured, quantity of the first pasty substance is filled into the dosing device, for example by a pour filling. But it is also conceivable that the dosing device itself is adapted to dose the quantity of the first pasty substance, therefore to measure it, and the filling operation is stopped when the suitable quantity of the first pasty substance is filled, that is dosed. The method according to the invention can therefore further comprise, dosing of the first pasty substance to be filled into the dosing device either before or during the filling of the dosing device. According to this the dosing device can take over a double dosing function, on the one hand the dosing device can measure, that is dose, the first pasty substance to be filled into the dosing device and on the other hand the dosing device can dose the quantity of the first pasty substance which is to be sprayed into the form. Thereby the quantity with which the dosing device is filled can correspond to the quantity which is sprayed through the dosing device into the form. But it is also conceivable that the quantity with which the dosing device is filled is larger than the quantity which is sprayed through the dosing device into the form. For example, because at multiple spray impulses always only part of the filled quantity is sprayed into the form, wherein after all spray impulses the filled quantity essentially corresponds to the quantity, which was sprayed into the form. But it is also conceivable that the quantity of the first pasty substance, which was filled into the dosing device is sufficient for performing spray impulses in several forms, in that case in each form there is only a part of the quantity which is filled into the dosing device.

The increase of the gas pressure in the dosing device respectively in the first end portion of the dosing device can for example be accomplished by a second end portion of the dosing device, after the filling of the first end portion of the dosing device, being connected to a gas pressure source, by which the gas pressure in the dosing device can be increased. For this purpose the dosing device shapes an enclosed space, in which the quantity of the filled first pasty substance is located. When into this space a gas is injected, for example air, the gas pressure within this space increases and upon the first pasty substance a force is exerted. When this force exceeds the surface tension of the pasty substance, which does not let it escape out of the at least one outlet nozzle, the first pasty substance is pressed out of the at least one outlet nozzle, that is sprayed, whereby droplets are formed which strike against the inner wall of the form and solidify there and form a structure. A plurality of droplets then accordingly forms a pattern. The spray behavior can thereby be steered through the duration and strength of the gas pressure. It can also be said that in the dosing device a gas pressure impulse is exerted which presses the first pasty substance out of the at least one outlet nozzle. This gas pressure impulse can be created through a gas pressure source, for example through a gas source in which a gas is held under pressure and by connection to the dosing device this gas can expand impulsively. But it is also conceivable that the dosing device is connected to a compressor which injects gas under pressure into the dosing device. It is also conceivable that in the second end portion of the dosing device there is a piston which through its movement in the direction of the first end portion compresses the gas between the piston and the pasty substance whereby the gas pressure is increased and the pasty substance is pressed out of the at least one outlet nozzle. But to a person skilled in the art there are also different possibilities known how the gas pressure can be increased in an enclosed space.

After the spraying on of the first pasty substance the form can be filled with a second pasty substance. This filling up can for example happen through a pour filling. It is also conceivable that another dosing device is inserted into the form after the first dosing device was removed out of the form and this is adapted to fill up the form with the second pasty substance. To a person skilled in the art a plurality of filling mechanisms is known for filling up a form with a pasty substance. All these filling mechanisms shall be encompassed by the invention.

The applying of the first pasty substance through the pressing out of a pasty substance by ease of increasing of the gas pressure can also be called a spray operation. Accordingly the dosing device can also be called a spray device. Compared to the known pour filling of a form a spray operation has thereby the advantage that different structures can be created that result in different patterns. Accordingly the spray operation allows a higher degree of design freedom than is possible through a pour filling. The spray behavior of the spray device thereby depends upon the viscosity of the first pasty substance and the applied gas pressure. By this factors the size of the droplets can be selected which are created by the spray device. The smaller the droplet size is, the stronger is the misting of the first pasty substance, a strong smoke screen for example can be used for applying glitter effects in the form. The bigger the droplet size is, the weaker is the smoke screen and structures with clear countering are applied respectively sprayed onto the inner wall of the form. The pattern of the thereby resulting structure can on the one hand be influenced by the spray behavior as well as through a movement of the pray device within the form. Furthermore it is conceivable that the spray device comprises not only one outlet nozzle but a plurality of outlet nozzles wherein the arrangement of the outlet nozzles gives the pattern to be sprayed out. In that case the arrangement of the outlet nozzles represents a kind of a template for the pattern to be applied.

With the method according to the invention it is possible for the first time also to manufacture lipstick mines with complex patterns out of at least two pasty substances.

The person skilled in the art thereby knows that even if the here described method is performed with only two pasty substances the spray device can also be filled several times with different pasty substances and this different pasty substances can be sprayed onto the inner wall of the form before the form then is filled up with the final pasty substance. It is also conceivable that before the filling up of the form with the second pasty substance several spray devices are inserted into the form one after another which spray on different pasty substances and/or different structures by which the final pattern results. Furthermore the person skilled in the art knows that even if the method described here only speaks of one spray device respectively dosing device and one form the method can also be performed simultaneously by several spray devices respectively dosing devices and forms for creating a plurality of lipstick mines simultaneously.

In one preferred embodiment of the method according to the invention the form is heated before and/or during the insertion of the first end portion of the dosing device. This heating ensures that the components contained in the pasty substances, by lipsticks for example waxes, do not solidify uncontrolled at the impingement on the inner wall of the form and hereby form veils. Furthermore the adhesion of the first pasty substance is better at a warm form than at a cold form, that is, the first pasty substance which is sprayed on through the dosing device remains in a heated form better at the spray on position than in a cold form. That is, the sprayed on structures do not run and the pattern stays focused and contoured. Furthermore the heating has the advantage that the second pasty substance spreads more easily in the form and enclosures better the sprayed on structures. The heating can be done by insertion of the form into an appropriate heat-bath or the form can be immersed by a heat carrier medium. But the person skilled in the art knows that various heating methods can be used depending on the material of which the forms are formed. For example in case of a form made of metal this form can be heated inductively wherein in case of a form made of an elastomeric material there must be present a heat transfer medium which heats the form. This heat transfer medium can be gaseous but also be liquid and can for the best possible heat transfer be brought into direct contact with the form.

In a further preferred embodiment of the method according to the invention the pasty substance is heated before and/or during the filling of the first end portion of the dosing device. This heating can be done either through a heat station before the filling and/or the dosing device itself can comprise means for heating. It is also conceivable that the dosing device is heated before the filling with the first pasty substance. The heating of the pasty substance on the one hand has the purpose that the pasty substance is transferred into a pourable condition and on the other hand comprises the advantage that the viscosity of the first pasty substance is controllable. Thereby the viscosity of the first pasty substance must be controlled so that it does not escape out of the at least one outlet nozzle by itself but must allow the pasty substance to be pressed out of the outlet nozzle through the increasing of the gas pressure.

In a further preferred embodiment of the method according to the invention the insertion of the first end portion of the dosing device into the form happens contactless. The first end portion of the dosing device is therefore in geometry and dimension adapted for being at least partially inserted into the form. Hereto, the outer diameter of the first end portion of the dosing device, or at least of the part of the first end portion of the dosing device to be inserted into the form, is smaller than the inner diameter of the form. The resulting clearance between the outer surface of the first end portion and the dosing device also determines the size of the sprayed on structure. The first pasty substance escapes at the at least one outlet nozzle within the so called spray cone. The bigger the clearance is the bigger is the diameter of the spray cone at the impact point on the inner wall of the form, that is, the bigger the clearance is the bigger is the sprayed on structure. Therefore, by the clearance the structure to be created can be influenced and thereby the pattern to be created can be influenced.

In a further preferred embodiment of the method according to the invention the dosing device or at least the first end portion of the dosing device is moved in the form during the increasing of the gas pressure. By this movement of the dosing device within the form, that is, by changing the position of the at least one outlet nozzle relatively to the inner wall of the form a pattern can be sprayed on the inner wall. For example, the dosing device can be turned whereby the at least one outlet nozzle remains on the same level by which a horizontal line structure can be created. But the dosing device can also be moved further into the form respectively out of the form for creating a vertical line structure. The person skilled in the art knows that the dosing device can be moved arbitrarily within the form for creating various structures and thereby creating various patterns. For example, the distance from the inner wall can also be varied for varying the spray cone in that way. Several of the mentioned movements can also be performed simultaneously. The person skilled in the art also knows that the described structures can be created not only through moving of the dosing device but as well through moving of the form. These movements can be computer controlled so that the same pattern results at each lipstick mine

In a further preferred embodiment of the method according to the invention the form, which is filled with the second pasty substance, is cooled after filling up so that the substance can solidify and then the ready lipstick mine can be removed out of the form by a removing station.

The above task is also solved by a dosing device for filling a form, in particular a form for forming of lipstick mines, with a pasty substance whereby the dosing device comprises a first end portion with at least one outlet nozzle whereby the first end portion is adapted to be inserted at least partially into the form and a second end portion with a means for selective supply of a pasty substance and for increasing the gas pressure in the first end portion of the dosing device.

In a preferred embodiment of the dosing device according to the invention the first end portion comprises a geometry and an outer diameter for being inserted into the form. That is, the outer diameter of the first end portion is for example smaller than the inner diameter of the form so that the first end portion can contactlessly be inserted into the form. The resulting clearance thereby determines the size of the spray cone of the pasty substance sprayed out of the at least one outlet nozzle and with that the resulting structure on the inner wall of the form. The first end portion of the dosing device can hereby comprise the same or at least a similar cross section like the form so that a contactless insertion can be ensured. But it is also conceivable that the first end portion and the form have a different cross section but these are coordinated in that way that the first end portion can be inserted contactlessly.

In a further preferred embodiment of the dosing device according to the invention in a first position the means for selective supply leads the pasty substance to the first end portion of the dosing device and in a second position the gas pressure is increased. Hereto the means for selective supply in a first position can for example connect the first end portion of the dosing device with a supply for the pasty substance and in a second position connect the first end portion of the dosing device with a gas pressure source. The means for selective supply can for example be a valve. This valve can for example comprise two inputs and one output and be adapted to that in each case selectively to establish a connection between the first input and the output and between the second input and the output. Valves of that kind are often called 3/2-valves. Thereby, the first input can be connected with the supply for the pasty substance, for example be connected with a reservoir in which the first pasty substance is being held and the second input can be connected with a gas pressure source, for example with a compressed air tank. The output can be connected with the first end portion of the dosing device. In a first position the valve can establish a connection between the first input and the output, therefore a connection between the reservoir holding the first pasty substance and the first end portion of the dosing device. Through this a certain quantity of pasty substance can be filled from the reservoir into the first end portion of the dosing device. In this first position the second input is closed, therefore there is no connection between the second input and the output. In the second position the valve can establish a connection between the second input and the output, therefore a connection between the gas pressure source, therefore for example the gas pressure tank and the first end portion of the dosing device. Hereby the gas pressure in the first end portion of the dosing device can be increased. In this second position the first input is closed, therefore there is no connection between the first input and the output so that no further pasty substance can get to the first end portion of the dosing device. Only when the valve is in its first position again, the first end portion of the dosing device can be filled once more. The person skilled in the art knows that even though here a valve has been described for selective supply of the pasty substance and the gas pressure also other means can be used that selectively establish always only one connection between the supply of the pasty substance and the first end portion of the dosing device respectively the gas pressure source and the first end portion of the dosing device. The duration for which the connection is established in each case can thereby define the quantity of the supplied pasty substance respectively the duration of the pressure pulse.

In a further preferred embodiment of the dosing device according to the invention the first end portion comprises a plurality of outlet nozzles. Thereby, for example the arrangement of the plurality of the outlet nozzles defines the pattern in which the structure of pasty substance is sprayed onto the inner wall of the form. For example, the first end portion can be designed tubular and along the tubular part there can be a plurality of outlet nozzles arranged in a helix-shape so that helix-shaped pattern of structures results when the first pasty substance is sprayed on the inner wall of the form. But the person skilled in the art knows further arrangements of the plurality of the outlet nozzles so that arbitrary structures and with that patterns can be created.

The above task is also solved by a system for forming of at least two pasty substances, in particular for forming of lipstick mines, whereby the system comprises a form, a first dosing device and a second dosing device. The first dosing device or at least a first end portion of the first dosing device is thereby adapted to be inserted into the form, whereby the part of the first dosing device which is inserted into the form comprises at least one outlet nozzle, whereby a first pasty substance is pressed out or sprayed out of the at least one outlet nozzle by increasing the gas pressure at least in the part of the first dosing device which is inserted into the form. The second dosing device is adapted to fill up the form with a second pasty substance after the first pasty substance is sprayed into the form by ease of the first dosing device. Thereby the first dosing device can also be called a spray device whereas the second dosing device can be called a pouring device. Thereby the spray device sprays the first pasty substance onto the inner wall of the form and the pouring device fills the form with the second pasty substance.

In a preferred embodiment of the system according to the invention the form is formed out of metal or an elastomeric material. The person skilled in the art knows that the material of the form can become attuned to the pasty substances to be used and the removing process to be used.

In a further preferred embodiment of the system according to the invention the system comprises means for moving the form relatively to the first and/or the second dosing device or means for moving the first and/or second dosing device relatively to the form. By ease of these means the dosing devices can be inserted into the form for filling those with the pasty substances in each case.

### BRIEF DESCRIPTION OF THE DRAWINGS

In a further preferred embodiment of the system the system further comprises a means for removing the pasty substances out of the form. Further advantages and features of the invention are to be seen in the following detailed description in which the invention is described in more detail and in relation to the embodiment examples in the attached figures.

The figures show:

FIG. 1 a schematic illustration of a lipstick mine formed out of two pasty substances;

FIG. 2 schematically in six steps the manufacturing of the lipstick mine shown in FIG. 1; and

FIG. 3 schematically in two steps the filling and spraying on of a first pasty substance for the manufacturing of the lipstick mine shown in FIG. 1.

### DETAILED DESCRIPTION

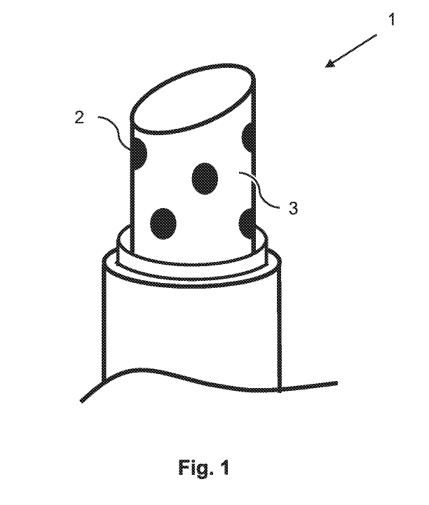

FIG. 1 schematically shows a lipstick mine 1 which is formed out of two pasty substances 2 and 3. The two pasty substances 2 and 3 have in the here shown embodiment example different colors. The first pasty substance 2 is in the here shown embodiment example dark illustrated and thereby has the form of dots and is used as eye-catcher in contrast to the second pasty substance 3 which has a lighter color and which is used as basic substance of the lipstick mine 1. The person skilled in the art will understand that the here shown embodiment example of the at least two pasty substances 2, 3 and their form and distribution is to be understood only exemplarily and that the invention also comprises other designs and patterns.

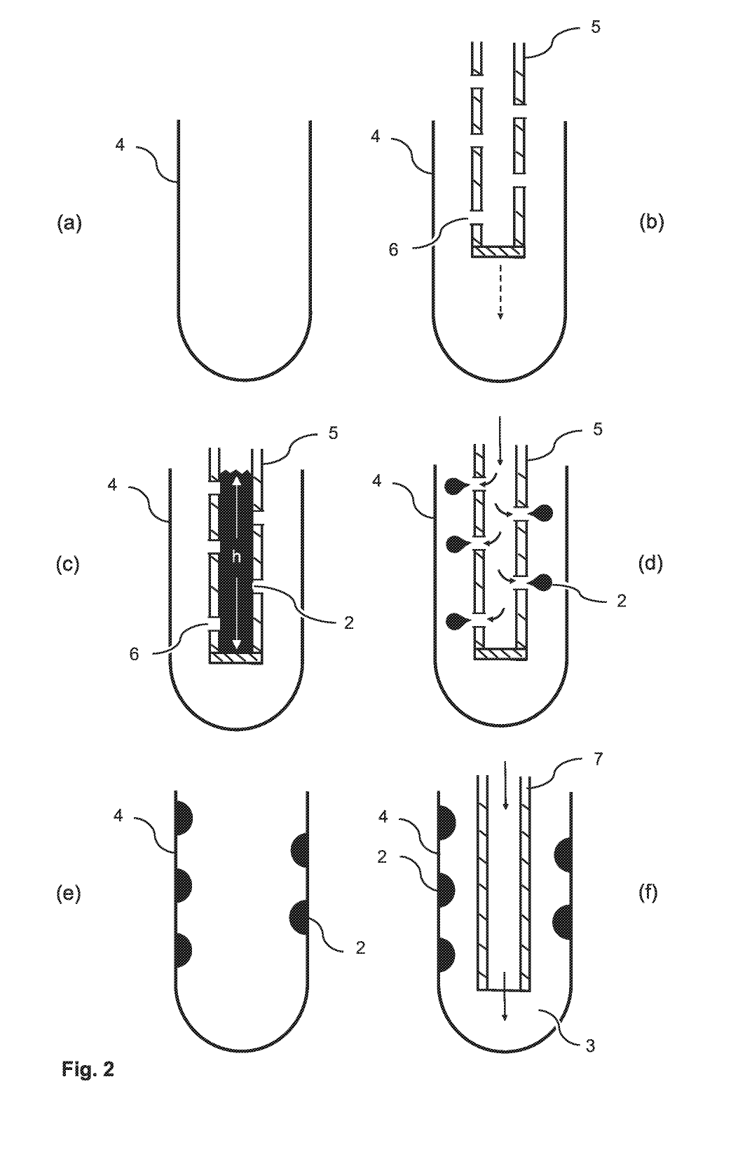

FIG. 2 schematically shows in six steps the manufacturing according to the invention of the lipstick mine 1 shown in FIG. 1. Hereby the form 4 is illustrated in FIG. 2 (a) which can be used for forming of the lipstick mine 1. The form 4 can be formed out of metal or an elastomer. Before the filling of the form 4 this can first of all be pre-tempered. This heating of the form 4 before the filling prevents that at the filling the pasty substances 2, 3 do not solidify immediately for creating a smoother surface and ensuring a controlled solidification. Furthermore the heating supports the adhesion of the pasty substance 2 on the inner wall of the form 4. The form 4 can for example be heated up to a temperature of 20° C. (68° F.) to 50° C. (122° F.), preferably the form is heated to room temperature if the form is formed out of an elastomer and to 35° C. (95° F.) if the form is formed out of metal. Afterwards as shown in FIG. 2 (b) a dosing device 5—here there is only shown a first end portion of the dosing device 5—is inserted into the form 4. The heating of the form 4 can happen before and/or during the insertion of the dosing device 5. The dosing device 5 is inserted into the form 4 contactlessly. That is, the dosing device 5 has no contact with the inner wall of the form 4. Accordingly a clearance results between the inner wall of the form 4 and the dosing device 5. The size of the clearance is dependent upon how big the inner diameter of the form 4 is compared to the outer diameter of the dosing device 5. For the dosing device 5 being contactlessly inserted into the form 4, the inner diameter of the form 4 must be bigger than the outer diameter of the dosing device 5. The clearance preferably amounts 0,5 mm (0,019 in) to 4 mm (0,157 in). But the person skilled in the art knows that other clearances can also be chosen. The dosing device 5 furthermore comprises in the here shown embodiment example a plurality of outlet nozzles 6 which can also be called spray holes. Out of these outlet nozzles 6, as shown in the subsequent steps, the first pasty substance is sprayed onto the inner wall of the form 4. The arrangement of the outlet nozzles 6 thereby defines the later pattern of the first pasty substance 2 on the inner wall of the form 4. The clearance determines the scaling between the pattern on the dosing device 5 and the sprayed on pattern on the inner wall of the form 4. The bigger the clearance is the bigger is the scaling.

The pasty substance 2 is before the filling into the dosing device 5 heated to a temperature that is above the melting point of all waxes bound therein. Especially among pasty substances 2 for lipsticks this is necessary for reaching a sufficient crystallization and with that a sufficient stiffness. The preheating temperature thereby is clearly above the drop point, for example 50° C. (122° F.), of the pasty substance 2 and is mass specific. For example the preheating temperature is 80° C. (176° F.).

The dosing device 5 is heated during and/or before the insertion into the form 4, this can be done by a heat station before the insertion or by heating means during the insertion. The dosing device 5 thereby is preferably heated to a temperature that is below the drop point of the pasty substance 2 to be filled in. The temperature of the dosing device 5 determines besides the composition of the pasty substance 2 substantially the viscosity of the pasty substance 2. Preferably the dosing device 5 is heated to a temperature of 47° C. (116° F.). But for example a range from room temperature up to 50° C. (122° F.) can be chosen. But the person skilled in the art knows that other temperatures can also be chosen. It is only to be ensured that the chosen temperature is of that kind that the pasty substance 2 comprises a viscosity that it does not escape out of the outlet nozzles 6 of the dosing device 5 on its own. Heretofore the outlet nozzles 6 are also to be chosen correspondingly to the viscosity. For low viscosity pasty substances 2 smaller outlet nozzles 6 are to be chosen than for higher viscosity pasty substances 2. The output diameter can be in a range of 0,1 mm (0,004 in) to 5 mm (0,197 in), preferably here an output diameter of 0,5 mm (0,019 in) is chosen. But the person skilled in the art knows that other output diameters can also be chosen and these can be chosen in accordance with the viscosity.

In FIG. 2 (c) the dosing device 5 is shown which is inserted into the form 4 and in which the pasty substance 2 is filled in. The pasty substance 2 thereby comprises a viscosity that it does not escape out of the outlet nozzles 6 on its own. The viscosity is controlled by the temperature of the dosing device 5, as described above. The filling height h of the pasty substance 2 in the dosing device 5 results in a determined volume, therefore a determined quantity of the pasty substance 2. The filling height h accordingly determines how much of the pasty substance 2 is dosed. Thereby the dosing device 5 can either comprise a level indicator which determines the quantity of the pasty substance 2 to be dosed or only a determined quantity of the pasty substance 2 to be dosed is inserted into the dosing device 5 whereby the quantity to be dosed has been determined by other means before. The person skilled in the art knows a plurality of possibilities how a determined quantity of a pasty substance 2 can be determined and can be filled into the dosing device 5. In the embodiment shown here the dosing device 5 respectively at least the portion of the dosing device 5 which is inserted into the form is tubular and has a same inner diameter over a determined height, for example 2,5 mm (0,098 in), at a determined filling height h therefore a determined volume, that is a determined quantity of pasty substance 2, is contained in the dosing device 5. Shall other quantities of pasty substance 2 be inserted into the form 4, dosing devices 5 with other inner diameters or other geometries can be used. It is also conceivable that insets can be inserted into the dosing device 5 which limit the volume being available for the dosing. Preferably in the dosing device 5 0,2 ml (0,007 fl oz) of pasty substance 2 are inserted. But here also other quantities can be chosen in the range between 0,5 ml (0,017 fl oz) to 5 ml (0,169 fl oz). But the person skilled in the art knows that other quantities can also be intended.

If the dosing device 5 is filled with the quantity of the pasty substance 2 to be dosed, therefore in the dosing device 5 a determined filling height h is reached, in the dosing device 5 a gas impulse, for example a compressed air impulse, is exerted onto the pasty substance 2 which is located in the dosing device 5. This gas impulse can be exerted by connecting the dosing device 5 to a gas pressure source. Alternatively or at least additionally within the dosing device—not shown here—a piston can move which abruptly reduces the space above the filling height h of the pasty substance 2 so that the impulse of the piston is transferred from the air onto the pasty substance 2. Even if it is spoken of compressed air here, the person skilled in the art knows that other gases should thereof also be encompassed and each increasing of the gas pressure above the filling height h of the pasty substance is seen as gas pressure impulse. Thereby the person skilled in the art knows, that this increasing of the gas pressure can be caused by any reaction or action which leads to the increase of the gas pressure.

FIG. 2 (d) shows that at increasing of the gas pressure in the dosing device 5 the pasty substance 2 which is located in the dosing device 5 is pressed out respectively sprayed out of the outlet nozzles 6 and afterwards impinges on the inner wall of the form 4. The duration of the increase of the gas pressure, which is the length respectively the duration of the pressure impulse thereby is dependent upon the quantity of the pasty substance 2 and the desired spray behavior. The duration should be chosen in that way that at least a significant part of the pasty substance 2 which is located in the dosing device 5 is pressed out respectively sprayed out of the outlet nozzles 6 so that no pasty substance 2 remains in the outlet nozzles 6. Preferably the duration of the compresses air impulse is about 0,2 seconds.

The arrangement of the outlet nozzles 6 as well as their distance from the inner wall of the form 4 thereby determines the pattern of the pasty substance 2. Thereby the spray behavior of the pasty substance 2 also strongly depends on the viscosity of the pasty substance 2. At a low viscosity a misting of the pasty substance 2 occurs, through which spray structures can be applied onto the inner wall of the form 4, for example for creating a glitter effect. At a higher viscosity of the pasty substance 2 however a sated application occurs through which sharp outlines are possible. The viscosity of the pasty substance 2 can thereby be regulated by the composition of the pasty substance 2 as well as the temperature conditioning of the dosing device 5 and can be adapted to the desired result. In the here shown embodiment example the viscosity of the pasty substance 2 is chosen in that way that sharp outlines occur. The spray behavior also depends on the increase of the gas pressure, the higher the gas pressure the stronger the misting. Preferably a strength of 2,0 bar (29 psi) is used. But the person skilled in the art knows that other pressures can also be used. For example pressures up to 6 bar (87 psi) can be used. But the limitation here results uniquely and exclusively by the material of the dosing device 5 and which spray behavior is desired. The person skilled in the art will recognize that the spray behavior can be regulated corresponding to the desired end result by the viscosity and the used pressure and therewith a desired spray behavior can be achieved by these parameters.

The pattern which results by the spraying on of the pasty substance 2 can thereby not only be predetermined by the arrangement of the outlet nozzles 6 in the dosing device 5 but can also result by a movement of the dosing device 5 within the form 4. For example the dosing device 5 can be rotated within the form 4 whereby long drown-out structures result on the inner wall of the form 4 in horizontal alignment. Alternatively or additionally the dosing device 5 can also be moved up or down for achieving vertical long drown-out structures.

But in the here shown embodiment the dosing device 5 persists in a position in relation to the form 4 so that in the here shown embodiment example point-shaped structures on the inner wall of the form 4 result. These point-shaped structures are shown in FIG. 2 (e) whereby the dosing device 5 in this figure has again already been removed out of the form 4. The resulting structures from pasty substance 2 in this embodiment example result in that way that the sprayed on pasty substance 2 directly solidifies at the impingement on the inner wall of the form 4 and persists at the impact point.

For creating further structures it is also conceivable that the dosing device 5 persists in the form 4 and is filled with another pasty substance and by another increase of the gas pressure further structures are sprayed on. It is also conceivable that another dosing device 5 is inserted into the form 4 whereby this further dosing device 5 has differently arranged outlet nozzles 6 for spraying on further structures. But in the here shown embodiment example with the dosing device 5 only one pasty substance 2 is sprayed on. The person skilled in the art should know that the here shown embodiment example and the resulting structure and its arrangement is only exemplarily intended and also other structures, patterns, arrangements are encompassed by the invention.

FIG. 2 (f) shows the form 4 with the pasty substance 2 sprayed on the inner wall as well as a second dosing device 7 inserted into the form 4 for filling up the form 4 with a second pasty substance 3. Thereby at the filling up of the form 4 the second dosing device 7 is moved out of the form 4. But the person skilled in the art also still knows other devices for filling up the form 4. For example, the form 4 can also be filled up merely by a pour filling. If a second dosing device 7 is inserted into the form 4 for filling up the form 4 with a second pasty substance 3 it should be only ensured that this is inserted contactlessly to the already sprayed on structure so that the sprayed on structure is not destroyed.

After the filling up of the form 4 with the second pasty substance 3 the form can be cooled down, for example to 0° C. (32° F.) for about 5 minutes so that the pasty substances can solidify and the created lipstick mine 1 can be taken out of the form 4 by means of a removing station.

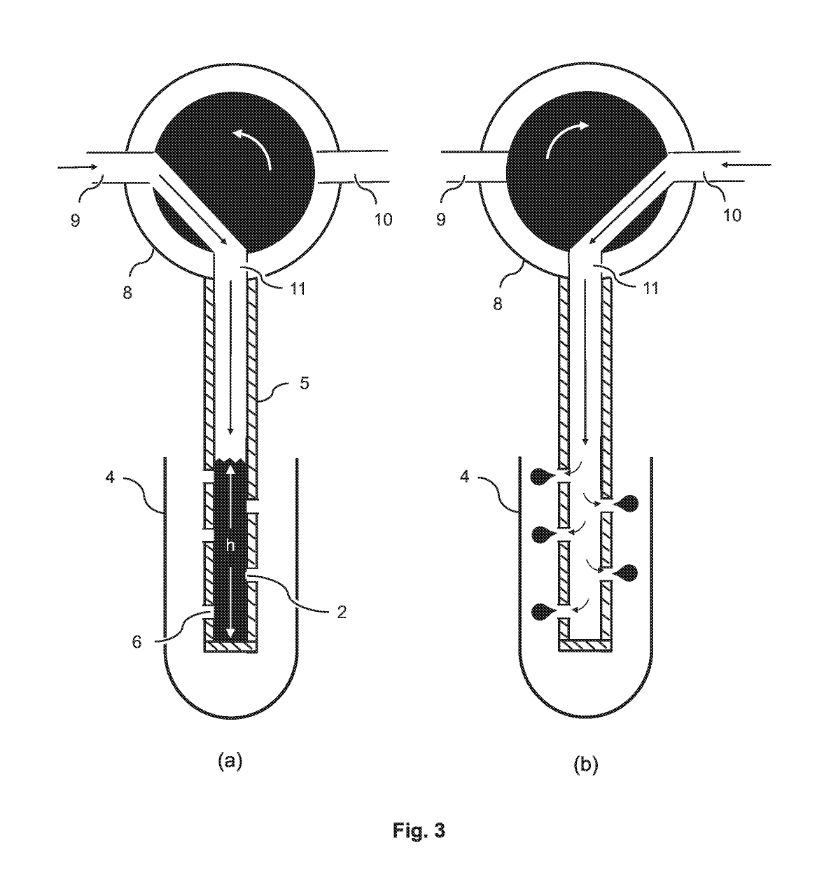

FIG. 3 (a) schematically shows the filling of the dosing device 5 inserted into the form 4 with the pasty substance 2. The dosing device 5 thereby comprises a first end portion on which a plurality of outlet nozzles 6 is located and which can be inserted into the form 4. At a second end portion of the dosing device 5 opposing the first end portion in the here shown embodiment example a rotary valve 8 is located. The rotary valve 8 comprises a first input 9 which can be connected to a supply of the pasty substance 2. The output 11 of the rotary valve 8 is connected to the first end portion of the dosing device 5. The rotary valve 8 establishes in the first position shown in FIG. 3 (a) a connection between the first input 9 and the output 11 so that the pasty substance 2, which can be applied to the first input 9, can get to the first end portion of the dosing device 5. Thereby the first input 9 can be connected to the output 11 for as long as a sufficient quantity of pasty substance 2 is filled into the first end portion of the dosing device 5. The pasty substance 2 in the first end portion of the dosing device 5 therefore reaches a determined filling height h. Afterwards the rotary valve 8 can be transferred from the first position shown in FIG. 3 (a) into a second position, in the here shown embodiment example for example by rotation of the rotary valve 8 so that a connection between a second input 10 and the output 11 is created. This is shown in FIG. 3 (b).

FIG. 3 (b) shows the rotary valve 8 in the second position in which a connection between the second input 10 and the output 11 is established. The second input 10 in the here shown embodiment example is connected to a gas pressure source which allows to increase the gas pressure in the first end portion of the dosing device 5 so that the pasty substance 2 which is located in the first end portion of the dosing device is pressed out respectively sprayed out of the outlet nozzles 6 of the dosing device. The duration of the gas pressure impulse can thereby be steered how long the rotary valve 8 persists in the second position. As soon as the rotary valve 8 is moved again from the second position, for example by rotation of the rotary valve 8 back into the first position, the connection between the second input 10 and the output 11 is interrupted. In the second position of the rotary valve 8 shown in FIG. 3 (b) the first input 9 of the rotary valve 8 is closed so that no further pasty substance 8 can get to the first end portion of the dosing device 5. The other way round in the first position of the rotary valve, as shown in FIG. 3 (b), the second input 10 is closed so that an increase of the gas pressure in the first end portion of the dosing device 5 cannot be caused.

The rotary valve 8 enables a smooth manufacturing process since the rotary valve 8 can be transferred from the first position for filling the first end portion of the dosing device 5 into the second position for the increase of the gas pressure. Thereby the change between filling and increase of the gas pressure can be steered by the rotation speed of the rotary valve 8 and can be adapted to the manufacturing process.

1. A method for filling a form with at least two pasty substances, wherein the form in particular is adapted for forming of lipstick mines, the method comprising:
Inserting a first end portion of a dosing device into the form, wherein the first end portion of the dosing device comprises at least one outlet nozzle;
Filling the first end portion of the dosing device with a first pasty substance;
Increasing the gas pressure in the first end portion of the dosing device, wherein the first pasty substance is pressed out through the pressure out of the at least one outlet nozzle;
Removing the first end portion of the dosing device from the form; and
Filling up the form with a second pasty substance.

2. The method according to claim 1, further comprising:
Heating the form before and/or during the insertion of the first end portion of the dosing device.

3. The method according to claim 1, further comprising:
Heating the first pasty substance before and/or during the filling of the first end portion of the dosing device.

4. The method according to claim 1, wherein inserting the first end portion of the dosing device into the form happens contactless.

5. The method according to claim 1, further comprising:
Filling the first end portion of the dosing device with another pasty substance, and
Increasing the gas pressure in the first end portion of the dosing device, before the form is filled up with the second pasty substance.

6. The method according to claim 1, further comprising:
Moving the first end portion of the dosing device in the form during the increase of the gas pressure.

7. The method according to claim 1, further comprising:
Cooling the form after filling the form with the second pasty substance.

8. A dosing device for filling a form with a pasty substance, in particular a form for forming of lipstick mines, the dosing device comprising:
A first end portion with at least one outlet nozzle, wherein the first end portion is adapted to be inserted at least partially into the form; and
a second end portion with a means for selective supply of a pasty substance and for increasing the gas pressure in the first end portion of the dosing device.

9. The dosing device according to claim 8, wherein the outer diameter of the first end portion is smaller than the inner diameter of the form.

10. The dosing device according to claim 8, wherein the means for selective supply in a first position supplies the pasty substance to the first end portion of the dosing device and in a second position increases the gas pressure.

11. The dosing device according to claim 10, wherein the means for selective supply is a valve, wherein
a first input of the valve with a supply for the pasty substance,
a second input of the valve with a supply for a gas pressure source, and an output of the valve is connected with the first end portion of the dosing device.

12. A system for forming of at least two pasty substances, in particular for forming of lipstick mines, the system comprising:
a form;
a first dosing device with a first end portion adapted to be inserted into the form, wherein the first end portion of the dosing device comprises at least one outlet nozzle, wherein a first pasty substance is pressed out of the at least one outlet nozzle through increasing the gas pressure in the first end portion of the dosing device;
and
a second dosing device adapted for filling up the form with a second pasty substance.

13. The system according to claim 12, wherein the form is formed out of metal or an elastomeric material.

14. The system according to claim 12, wherein the system further comprises:
means for moving the form relative to the first and/or second dosing device; or
means for moving the first and/or second dosing device relative to the form.

15. The system according to claim 12, wherein the system further comprises:
A means for removing the pasty substances out of the form.
